(19) United States
(12) Patent Application Publication
(10) Pub. No.: US 2016/0288489 A1
(43) Pub. Date: Oct. 6, 2016

(54) METHOD FOR THE CONTROL OF THE ROTATIONAL SPEED FOR A DRIVE DEVICE OF A PRINTING ROLL

(71) Applicant: WINDMÖLLER & HÖLSCHER KG, Lengerich (DE)

(72) Inventors: Frank WESTHOF, Recke (DE); Wolfgang KNAPHEIDE, Lienen (DE); Mario FRANKENBERG, Osnabruck (DE); Uwe HOWELMEYER, Ibbenburen (DE); Wolfgang SPREHE, Steinfeld (DE); Frank GUNSCHERA, Osnabruck (DE)

(21) Appl. No.: 14/917,774

(22) PCT Filed: Jun. 30, 2014
(86) PCT No.: PCT/EP2014/063861

§ 371 Date: Jun. 22, 2016

(30) Foreign Application Priority Data
Sep. 9, 2013 (DE) 10 2013 109 851.7

(51) Int. Cl. B41F 33/00; B41F 13/004; B41F 31/00; B41F 5/24

(52) U.S. Cl. CPC B41F 33/00; B41F 5/24; B41F 13/0045; B41F 31/004

(57) ABSTRACT

The invention relates to a method for the control of the rotational speed for a drive device (20) of a printing roll (10) with a resilient printing sleeve (12) of a flexo printing press (100) comprising the following steps:
Determination of a first rotational speed (V1) of the printing roll (10) in the free wheeling without active drive device (20) with a first adjusting value (B1),
Determination of a second rotational speed (V2) of the printing roll (10) in the free wheeling without active drive device (20) with a second adjusting value (B2),
Generation of a control curve (30) of the rotational speed related to the adjusting value on the basis of the determination steps,
Usage of the control curve (30) for the control of the rotational speed of the printing roll (10) with an active drive device (20).

The present invention relates to a method for the control of the rotational speed for a drive device of a printing roll with a resilient printing sleeve of a flexo printing press and a flexo printing press with a control unit for performing such a method.

It is basically known that with flexo printing press a printing roll with a resilient printing sleeve is used. Often these printing sleeves are also named printing plate or cliché and pushed to the printing roll. A basic feature for the printing functionality of this printing sleeve is the resilient configuration. This leads to the fact that during printing a deformation of the resilient printing sleeve occurs. Is the supply of the printing roll altered relatively to other presses, also the printing situation for the resilient printing sleeve is altered. With altered printing situations also the crushing situation alters accordingly.

It has turned out that in dependence of the crush situation different speeds for the printing roll are adjusted. Particularly, the printing situation alters the speed of the respective printing roll by an alteration of the crush situation of the resilient printing sleeve. Particularly, by an increase of the pressure with an increase of the crushing an increase of the speed of the printing roll occurs. An increased speed, however, leads to the fact that this increase of the speed has to be slowed down. This occurs for example by a corresponding braking effect of the drive device. This continuous slowing down of the printing roll leads to an increased wear out of the drive device. If a slowing down is avoided an undesired slip between the printing roll and for example the printing medium or another press can occur. This slip leads to a friction of both components which can lead to an increased wear out of these components. Basically, this problem was already described for example in DE 10 2010 015 628 A1. The solution in this document provides that the actual printing situation in form of indentation depth of the printing sleeve has to be determined. On basis of this indentation depth a control for the elimination of this effect has to be performed. However, it is a crucial disadvantage that this determination of the indentation depth occurs with a high constructional effort. Particularly, complex sensor systems are necessary in order to determine these parameters.

Thus it is the object of the present invention to at least partially solve the previously described disadvantages. Particularly, it is the object of the present invention to provide the control of the rotational speed for the drive device of the printing roll in a cost efficient and simple manner.

The previous object is solved by a method with the features of claim 1 and a flexo printing press with the features of claim 11. Further features and details of the invention result from the dependent claims, the description and the drawings. Thereby, features and details which are described in connection with the method according to the invention naturally also apply in connection with the flexo printing press according to the invention and vice versa so that according to the disclosure for the single aspects of the invention it can always be reciprocally related to.

A method according to the invention serves for the control of the rotational speed for a drive device of a printing roll with a resilient printing sleeve of a flexo printing sleeve of a flexo printing press. Such a method according to the invention comprises the following steps:
determination of a first rotational speed of the printing roll in free wheeling without an active drive device with a first adjusting value,
determination of a second rotational speed of the printing roll in free wheeling without an active drive device with a second adjusting value,
generation of a control curve of a rotational speed related to an adjusting value on basis of the determination steps,
use of the control curve for the control of the rotational speed of the printing roll with an active drive device.

With a method according to the invention a sensory determination of the indentation depth in a direct manner can be avoided. Rather, as so to say “simulated free wheeling” the configured altered speed is determined on basis of the described crushing effect of the resilient printing sleeve. Therewith, so to say the crushing in an indirect manner and the effect of the crushing in a direct manner can be determined. This simulated free wheeling serves for determining the effect and therewith the occurring relative speed to the printing medium or to the contacting presses. Subsequently, on basis of this simulated free wheeling an adjustment in form of a use of the determined or generated control curve can be performed.

By adjusting values within the sense of the present invention distances have to be understood which are configured between a printing roll and a neighbouring press. This can be the adjusting value between the printing roll and the anilox roll and/or the adjusting value between the printing roll and the counter printing roll. Particularly, it is thereby related to the adjusting value in order to alter the pressing force to the printing medium. Is the adjusting value altered, the printing situation for the resilient printing sleeves alters accordingly. Accordingly, with a method according to the invention not only to one single value but to at least two adjusting values the relating rotational speed is determined. In this simulated free wheeling for the control curve at least two values can be provided which can serve as a basis for the generation of the control curve by the determination. Thereby, the control curve can be generated through any mathematic or technical measurement method. Beneath an only linear connection of the two determined measurement points for the first and second adjusting value likewise complicated algorithms can generate curved and not linear curve progressions for the control curve.

Within the scope of the present invention the method can be used for a printing roll with a fitted resilient printing sleeve and also for a printing roll with an adjusted resilient printing sleeve. Naturally, the effect according to the invention can also be achieved when the printing roll is configured mainly completely from a resilient material as a printing sleeve.

According to the invention it has to be determined between an active and passive drive device. By an active drive device the switched on drive device has to be understood by which an active torque is exerted from the drive device on the printing roll for generating the rotational speed. By a non-active drive device or a passive drive device a simulated free wheeling has to be understood. If the drive device is for example an electric motor, this means that a rotor of the drive device is further rotating by the printing roll and the corresponding drive from the printing medium or a contacting press. Accordingly, the drive device is further in the rotational operation in the passive state such that the rotational speed which is adjusted in the simulated free wheeling can be recognized by the same sensors like it is the case for the regulation of the drive device. Therewith, no additional sensor units are necessary for the method according to the invention in order to perform the determination according to the invention of the first and second rotational speed. In comparison to known methods the reduction of the construction effort and the prevention of additional sensors which have to be adjusted are therewith main advantages.

The use of the control curve can either be used as a target value curve for a regulation and also for a target value curve for the control. In both cases the control curve can provide the basic values for the subsequent control. Naturally, the control curve can also be used for the adjustment of the rotational speed of a counter pressure roll, an anilox roll or other rolls of the flexo printing press.

If in the course of printing an alteration of the adjusting values is performed in order to for example achieve an alteration of the printing image it can be reverted to a generated control curve. An alteration of the adjusting value will lead to an alteration of the crushing situation of the printing sleeve. This alteration of the crushing situation is however considered when using the control curve when controlling the rotational speed of the printing roll. The altered crushing effect is accordingly compensated at least partially by an altered control on basis of the control curve for the rotational speed of the printing roll.

By a method according to the invention therewith at least partially a compensation of the described crushing effect occurs. This leads to the fact that the slip between the contacting components or the contacting rolls is reduced or prevented. Further, it is possible to protect the drive device from unnecessarily high wear out. In comparison to the known method a possibility of controlling the compensation of the described crushing effect can be provided in a cost efficient and fast and also simple manner. Particularly, such a method is used with a register released printing. The determination of the relative speed or the rotational speed to the adjusting values occurs thereby for example in the units meter per second or rounds per minute. The determination of the single values or the generation of the control curve is thereby specific for the used printing roll and/or the used resilient printing sleeve. If another resilient printing sleeve is drawn up to the printing roll, the method according to the invention should advantageously be performed again in order to generate the specific control curve for this operation and this resilient printing sleeve.

A method according to the invention can be further improved in that the control curve is at least partially generated as a linear course between the determined values and the adjusting values. This is a particular simple and cost efficient and also fast generation of the control curve. The both determined values in a diagram are simply connected to one another with a linear line. A particularly simple mathematical algorithm allows in this manner a particularly cost efficient generation of a corresponding control unit. Such a control curve serves as a basis for a subsequent control in form of the control and/or of a regulation of a particularly simple control basis.

A further advantage can be achieved when with the method according to the invention it is used for a register free print. By a register-free print a print has to be understood which particularly comprises only one colour. Therewith, no registration tolerance meaning no clean overlap of the single colour sections has to be considered. The freedom of register leads to the fact that an alteration of the printing speed can be accepted by a control of the rotational speed of the printing roll according to the invention. With a register tolerance it is an advantage when the register tolerance is taken into account by the control of the rotational speed. This can for example occur by an intervention of the rotational speed of different inking systems or the coordination by the control of the rotational speed of the printing rolls of different inking systems.

A further advantage is when with the method according to the invention at least one further rotational speed of the printing roll is determined in the free wheeling without an active drive device with the further adjusting value. With other words, at least at a third point of time and with the third adjusting value a third rotational speed or even more rotational speeds are determined with multiple adjusting values. This results in a high accuracy for the generation of the control curve. Thus, it can be reverted to a broader data basis for the generation of the control curve. The course between the single data points by this determination can likewise be configured linear so that the different inclined layers with the different inclinations in result are part of the control curve. Likewise the curve can be generated from a plurality of discrete values in form of a step-like configuration. In all these cases the increase of the data points, meaning the further amount of further rotational speeds with further adjusting values, effects a higher accuracy with the generation of the control curve.

Likewise it is an advantage when with the method according to the invention the determination steps are performed continuously or mainly continuously with the continuous or mainly continuous alteration of the adjusting value. With other words, a mainly continuous curve is recorded as a control curve and is therewith generated. The printing roll is moved towards the corresponding contacting counter printing roll and the printing medium and therewith the adjusting value is altered. At the same time the adjusting rotational speed is determined in the simulated free wheeling in a continuous or mainly continuous manner. This taken down curve is the generated control curve. Thereby, this can be so to say a first calibration procedure with which the printing roll is moved across the whole adjusting area of the adjusting value. This generates a mainly continuous curve which is generated on the basis of a complex calibration procedure but comprises accordingly a significantly increased accuracy. Such an increased accuracy comes along with a more accurate adjustment during the use for the control function.

Likewise it is an advantage when with a method according to the invention the control curve is used for the control of the rotational speed of an anilox roll. This additional use situation for the control curve comes along with a further improvement concerning the compensation of the described crushing effect. Thus the anilox roll preferably turns with the same or mainly the same rotational speed like the printing roll. Naturally, also the control of other rotational speeds, like for example the rotational speed of the counter printing roll, is possible on the basis of the control curve. Therewith one and the same generated control curve which is specific for the resilient printing sleeve can be used for the control of multiple different rotational speeds of different components.

A further advantage can be achieved when with the method according to the invention during the control of the rotational speed of the printing roll a constructive undersize of the diameter of the printing roll is considered.

Thus, the user of a printing machine can consider the crushing effect already when ordering the printing roll. By a constructional undersize, meaning a reduction of the diameter of the printing roll, an alteration of the speed of the printing roll, meaning particularly an acceleration of the printing roll by the pressure effect, is compensated. Therewith, this constructive undersize can already be considered with a method which is based on the order of the clients or the user of the printer machine.

Likewise it is an advantage when with the method according to the invention the generated control curve in relation to the used resilient printing sleeve and/or in relation to the printing roll is saved. The storage occurs for example in a database relative to the resilient printing sleeve. Thus, a library can be generated which provides specifically generated control curves to the different resilient printing sleeves. The described calibration, namely the performance of a method according to the invention, only has to be performed with a completely new resilient printing sleeve. Is an already used resilient printing sleeve drawn up, the generated control curve saved in the database can be recalled. This accelerates the use during printing of the flexo printing press during a change between the different resilient printing sleeves.

With the method according to the previous paragraph it is further an advantage when the generated control curve is compared to a saved control curve. Particularly, this comparison occurs with a control curve from a database. Thus, a specific standard deviation of differently generated control curves can be performed to a specific resilient printing sleeve. The standard deviation serves for the improvement of the subsequent use for the control of the rotational speed of the printing roll. Likewise, a monitoring concerning the alteration of the specifically generated control curve can be a hint to an alteration or a wear out of the resilient printing sleeve. Thus, here an early warning functionality can be provided by a comparison with the saved generated control curve.

A method according to the invention can be further improved in that the control curve is used in comparison to the rotational speed of at least one further roll, particularly an anilox roll and/or a counter printing roll. Like already described it is particularly related to the relative speed between the printing roll and an at least one further roll. By the use of the control curve for multiple rotating components particularly a slip between these rotating components can be effectively prevented.

Further, the subject matter of the present invention is a flexo printing press comprising a printing roll with a resilient printing sleeve and a control unit for the control of the rotational speed of the printing roll. A flexo printing press according to the invention is characterized in that the control unit is configured for the configuration of a method according to the invention. Accordingly, a flexo printing press according to the invention comprises the same advantages like they are described in detail regarding the method according to the invention.

Further advantages, features and details of the invention result from the subsequent description in which embodiments of the invention are described in detail in relation to the drawings. Thereby, the described features in the claims and in the description can be essential for the invention each single for themselves or in any combination. It is schematically shown:

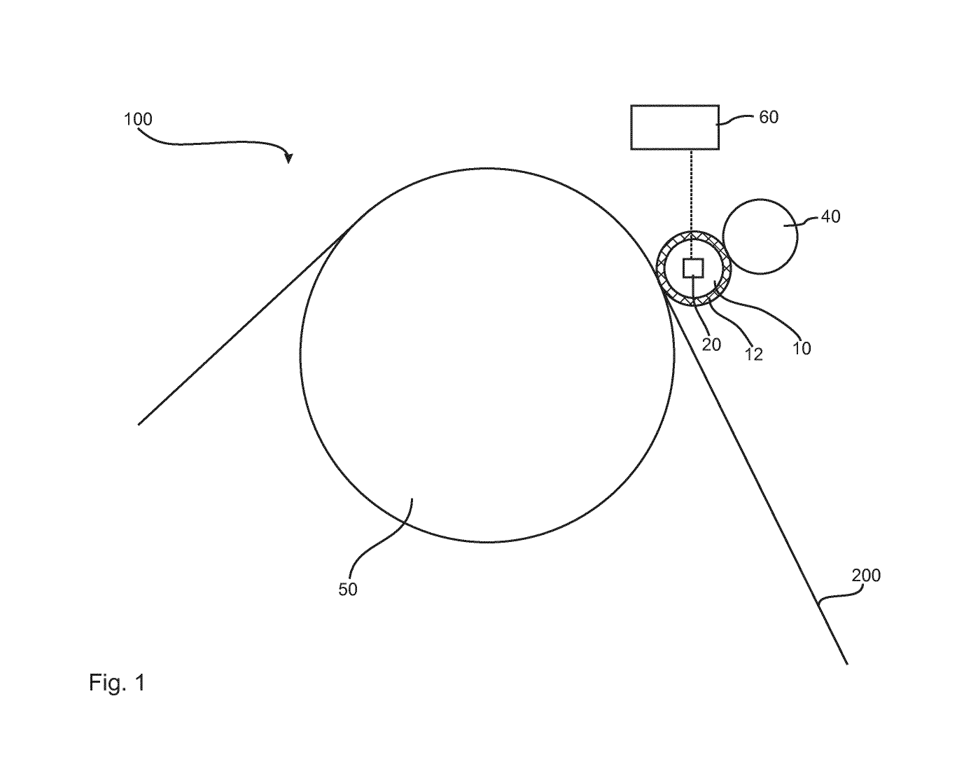

FIG. 1 a first embodiment of a flexo printing press according to the invention,

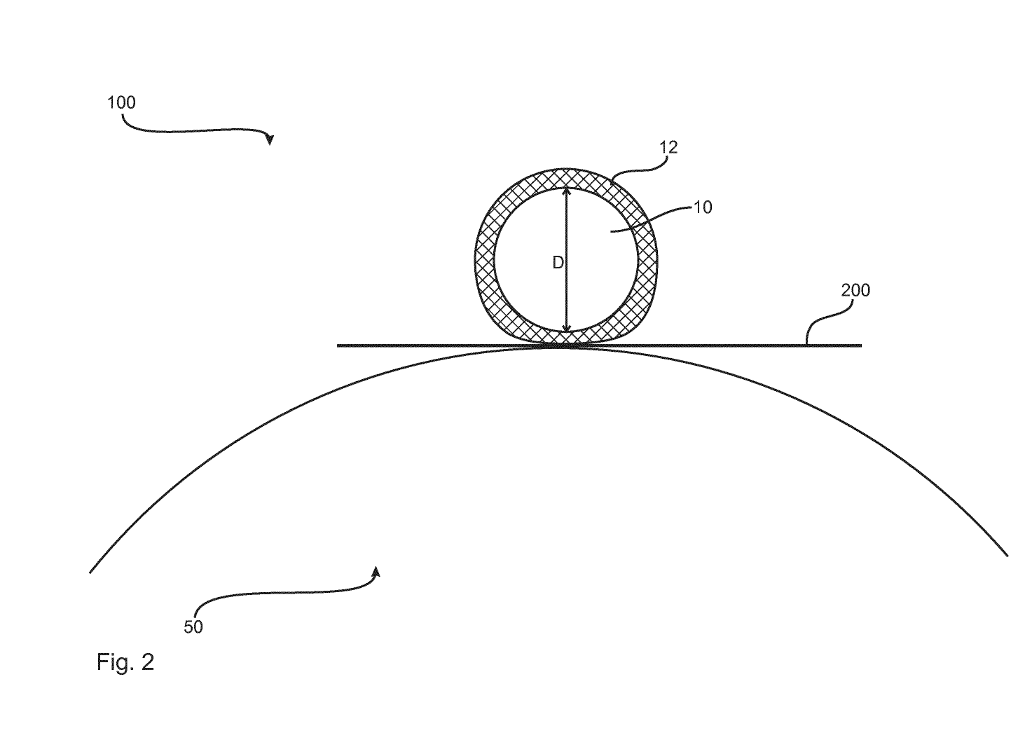

FIG. 2 the embodiment of FIG. 1 with the resilient printing sleeve in a crimped situation,

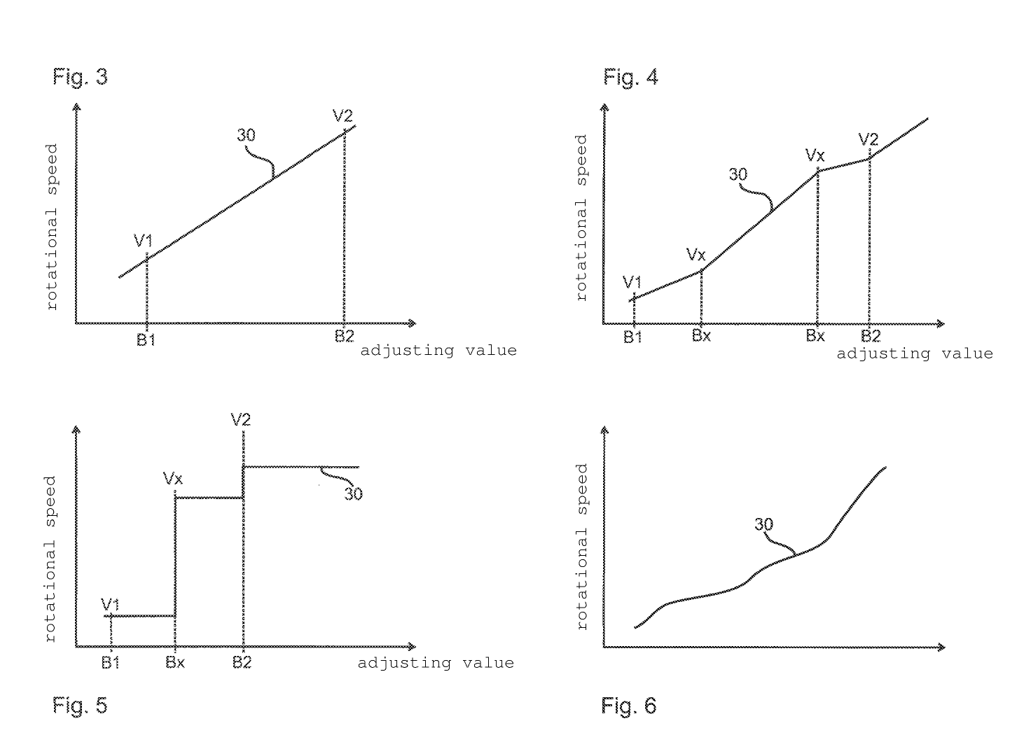

FIG. 3 a first embodiment of a generated control curve,

FIG. 4 a further embodiment of a generated control curve,

FIG. 5 a further embodiment of a generated control curve and

FIG. 6 a further embodiment of a generated control curve.

In FIG. 1 an embodiment is shown schematically of a flexo printing press 100 according to the invention. This flexo printing press 100 comprises a counter printing roller 50, an anilox roller 40 and a printing roller 10. On the printing roller 10 a resilient printing sleeve 12 is assembled which can for example be configured as a printing plate. Further, a drive device 10 for example in form of an electric motor is intended which serves for the drive of the printing roll 10. Likewise a control unit 60 is shown schematically which is coupled to the drive device 20 for the control of the rotational speed of the printing roll 10 via a data connection. Likewise in FIG. 1 the curve of the printing medium 200 can be recognized.

In FIG. 1 a flexo printing press 100 with an inking system from an anilox roller 40 and a printing roller 10 is schematically shown. With this embodiment it is a register-free print with a single colour. Naturally, further inking systems can be intended wherein for each inking system an anilox roller 40 and a printing roll 10 can be intended.

In FIG. 2 a crushing situation is shown. Thereby, a crushing situation for the printing sleeve 12 is configured between the printing roll 10 and the counter printing roll 50. With the conveyance of the printing medium 200 between both rollers 10 and 50 the supply in FIG. 2 occurs top down. The printing roll 10 is moved towards the counter printing roll 50 and the printing gap in between is decreased. Through this printing gap the printing medium 200 proceeds. With an alteration of the adjusting value after banding of the resilient printing sleeve 12 at the printing medium 200 subsequently a crushing of the resilient printing sleeve 12 occurs like it is schematically shown in FIG. 2. This crushing leads to a variation of the rotational speed of the printing roll 10. This variation leads to an increased wear out of the drive device 20 or to a slip at the printing medium 200 so that here a wear out at the printing medium 200 and at the resilient printing sleeve 12 can be recognized. In order to prevent the crushing effect and the therewith described problems the method according to the invention is performed like subsequently described.

In a first point of time, meaning with a first adjusting value B1, in a simulated free wheeling, meaning without active drive device 20, the first rotational speed V1 of the printing roll 10 is determined. Subsequently, in a second adjusting value B2 a second rotational speed V2 of the printing roll 10 is determined. These two determined values are registered in the according diagram which records the rotational speed via the adjusting value. Examples for such diagrams and control curves 30 generated therefrom are in FIGS. 3 to 6.

FIG. 3 is a particularly simple and cost efficient configuration of the generated control curve 30. Thus, here the at least demanded certain parameters for the first adjusting value B1 and the second adjusting value B2 are drawn in. The according rotational speeds V1 and V2 establish points in this diagram which are connected to one another along a line in this embodiment. Herein, for the generation of the control curve 30 a linear relation between the rotational speeds and the adjusting value is taken as a basis. The corresponding generation of the control curve can be achieved accordingly with a simple and cost efficient generating algorithm. On basis of this control curve 30 now an adjustment or control of the rotational speed of the printing roll 10 occurs via an actively appearing drive device 20.

In FIG. 4 a further variation of the control curve 30 is shown. With this variation a respective further rotational speed Vx is determined to two further adjusting values Bx in addition to the first adjusting value B1 and to the second adjusting value B2, respectively. The courses between the single parameter values in the diameter according FIG. 4 are on a linear basis. Thus, differently inclined lines between the single data values are established like shown in the control curve 30 according to FIG. 4. In comparison to FIG. 3 the effort for the determination of the values is greater, but however a higher accuracy with the generation of the control curve 30 is reached. Alternatively or in combination also an embodiment according to FIG. 5 can be chosen. Thus, to the additional values or data values in the diagram of the rotational speed a step function can be specified via the adjusting value.

If the adjusting value is mainly continuously adapted or varied and the rotational speed is monitored continuously or mainly continuously, in this manner a complete free control curve 30 can be generated via writing down this correlation. This is shown in FIG. 6. The calibration effort is thus the highest, however an ideal or optimized accuracy during the generation of the control curve 30 is achieved.

The previous description of the embodiments describes the present invention only within the scope of examples. Naturally, single features of the embodiments as far as technically meaningful can be freely combined with one another without leaving the scope of the present invention.

### REFERENCE SIGNS

10 Printing roll
12 Resilient printing sleeve
20 Drive device
30 Control curve
40 Anilox roll
50 Counter printing roll
60 Control unit
100 Flexo printing press
200 Printing medium
B1 First adjusting value
B2 Second adjusting value
Bx Further adjusting value
D Diameter of the printing roll
V1 First rotational speed
V2 Second rotational speed
Vx Further rotational speed

1. A method for the control of the rotational speed for a drive device of a printing roll with a resilient printing sleeve of a flexo printing press comprising the following steps:
Determination of a first rotational speed (V1) of the printing roll in the free wheeling without active drive device with a first adjusting value,
Determination of a second rotational speed (V2) of the printing roll in the free wheeling without active drive device with a second adjusting value,
Generation of a control curve of the rotational speed related to the adjusting value on the basis of the determination steps,
Usage of the control curve for the control of the rotational speed of the printing roll with an active drive device.

2. The method according to claim 1, wherein the control curve is generated at least sectionally as a linear course between the to be determined adjusting values.

3. The method according to claim 1, wherein this is used for a register-free print.

4. The method according to one of the preceding claim 1, wherein at least a further rotational speed (Vx) of the printing roll is determined in the free wheeling without an active drive device with a further adjusting value (Bx).

5. The method according to claim 1, wherein the determination steps are performed continuously or mainly continuously in a continuous or mainly continuous alteration of the adjusting value.

6. The method according to claim 1, wherein the control curve is also used for the control of the rotational speed of an anilox roll.

7. The method according to claim 1, wherein during the control of the rotational speed of the printing roll a constructive undersize of the diameter of the printing roll is considered.

8. The method according to claim 1, wherein the generated control curve is saved in relation to the used resilient printing sleeve and/or in relation to the printing roll.

9. The method according to claim 8, characterized in that, wherein the generated control curve is compared to a saved control curve.

10. The method according to claim 1, wherein the control curve is used in comparison to the rotational speed of at least one further roll, particularly an anilox roll and/or a counter printing roll.

11. A flexo printing press comprising a printing roll with a resilient printing sleeve and a control unit for the control of the rotational speed of the printing roll, wherein the control unit is configured for the performance of a method with the features of claim 1.
